(19) United States
(12) Patent Application Publication
(10) Pub. No.: US 2022/0398140 A1
(43) Pub. Date: Dec. 15, 2022

(54) ENABLING MICROAPP ACCESS BASED ON DETERMINED APPLICATION STATES AND USER-INITIATED TRIGGERING EVENTS

(71) Applicant: Citrix Systems, Inc., Fort Lauderdale, FL (US)

(72) Inventor: Manbinder Pal Singh, Coral Springs, FL (US)

(21) Appl. No.: 17/343,115

(22) Filed: Jun. 9, 2021

(51) Int. Cl. G06F 9/54; G06F 9/451

(52) U.S. Cl. CPC G06F 9/542; G06F 9/546; G06F 9/543; G06F 9/451; G06F 3/0482

(57) ABSTRACT

One disclosed method involves receiving, by a first application managed by an operating system, first data indicating that a second application managed by the operating system is in a first state; receiving, by the first application, second data indicating that a first user input has been provided to a client device; determining, by the first application and based at least in part on the first data and the second data, that the first user input occurred while the second application was in the first state; and causing, by the first application and based at least in part on the first user input having occurred while the second application was in the first state, the client device to present a first user interface for a third application, the first user interface configured to cause the third application to take a first action with respect to a fourth application in response to a second user input to the client device.

### BACKGROUND

Various systems have been developed that allow client devices to access applications and/or data files over a network. Certain products offered by Citrix Systems, Inc., of Fort Lauderdale, Fla., including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method comprises receiving, by a first application managed by an operating system, first data indicating that a second application managed by the operating system is in a first state; receiving, by the first application, second data indicating that a first user input has been provided to a client device; determining, by the first application and based at least in part on the first data and the second data, that the first user input occurred while the second application was in the first state; and causing, by the first application and based at least in part on the first user input having occurred while the second application was in the first state, the client device to present a first user interface for a third application, the first user interface configured to cause the third application to take a first action with respect to a fourth application in response to a second user input to the client device.

In some embodiments, a system comprises at least one processor, and at least one computer-readable medium encoded with instructions which, when executed by the at least one processor, cause the system to receive, by a first application managed by an operating system, first data indicating that a second application managed by the operating system is in a first state, to receive, by the first application, second data indicating that a first user input has been provided to a client device, to determine, by the first application and based at least in part on the first data and the second data, that the first user input occurred while the second application was in the first state, and to cause, by the first application and based at least in part on the first user input having occurred while the second application was in the first state, the client device to present a first user interface for a third application, the first user interface configured to cause the third application to take a first action with respect to a fourth application in response to a second user input to the client device.

In some embodiments, at least one non-transitory computer-readable medium is encoded with instructions which, when executed by at least one processor of a computing system, cause the computing system to receive, by a first application managed by an operating system, first data indicating that a second application managed by the operating system is in a first state, to receive, by the first application, second data indicating that a first user input has been provided to a client device, to determine, by the first application and based at least in part on the first data and the second data, that the first user input occurred while the second application was in the first state, and to cause, by the first application and based at least in part on the first user input having occurred while the second application was in the first state, the client device to present a first user interface for a third application, the first user interface configured to cause the third application to take a first action with respect to a fourth application in response to a second user input to the client device.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example system for enabling microapp access based on determined application states and user-initiated triggering events in accordance with some aspects of the present disclosure;

FIG. 1B shows a first example display screen of the client device shown in FIG. 1A;

FIG. 1C shows a second example display screen of the client device shown in FIG. 1A illustrating how a user may select text or other content presented by a user interface of a user application;

FIG. 1D shows a third example display screen of the client device shown in FIG. 1A;

FIG. 1E shows a fourth example display screen of the client device shown in FIG. 1A;

FIG. 1F shows a fifth example display screen of the client device shown in FIG. 1A;

FIG. 2 is a diagram of a network environment in which some embodiments of the context-based microapp action recommendation system disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 5D shows how a display screen may appear when an intelligent activity feed feature of a multi-resource management system, such as that shown in FIG. 5C, is employed;

FIG. 6A shows a first portion of a sequence diagram illustrating messages that may be exchanged amongst various components of a multi-resource access system to enable certain aspects of the functionality disclosed herein; and

FIG. 6B shows a second portion of a sequence diagram illustrating messages that may be exchanged amongst various components of a multi-resource access system to enable certain aspects of the functionality disclosed herein.

### DETAILED DESCRIPTION

For purposes of reading the description of the various embodiments below, the following descriptions of the sections of the specification and their respective contents may be helpful:

Section A provides an introduction to example embodiments of a system for enabling microapp access based on determined application states and user-initiated triggering events in accordance with some aspects of the present disclosure;

Section B describes a network environment which may be useful for practicing embodiments described herein;

Section C describes a computing system which may be useful for practicing embodiments described herein;

Section D describes embodiments of systems and methods for accessing computing resources using a cloud computing environment;

Section E describes embodiments of systems and methods for managing and streamlining access by clients to a variety of resources;

Section F provides a more detailed description of example embodiments of the system for enabling microapp access based on determined application states and user-initiated triggering events introduced in Section A; and

Section G describes example implementations of methods, systems/devices, and computer-readable media in accordance with the present disclosure.

A. Introduction to Illustrative Embodiments of a System for Enabling Microapp Access Based on Determined Application States and User-Initiated Triggering Events

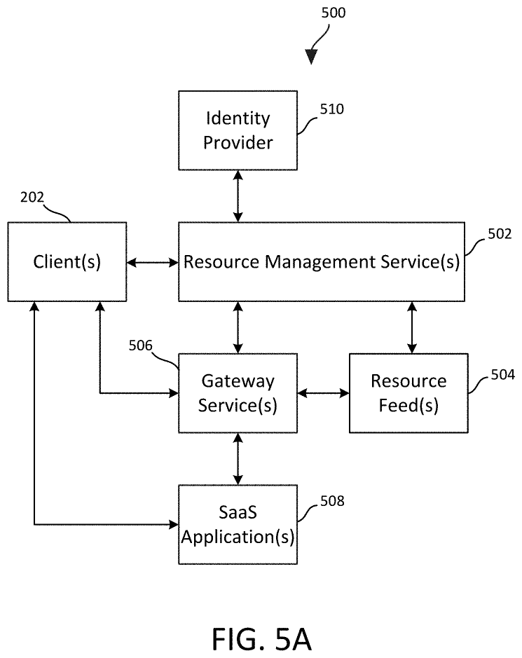

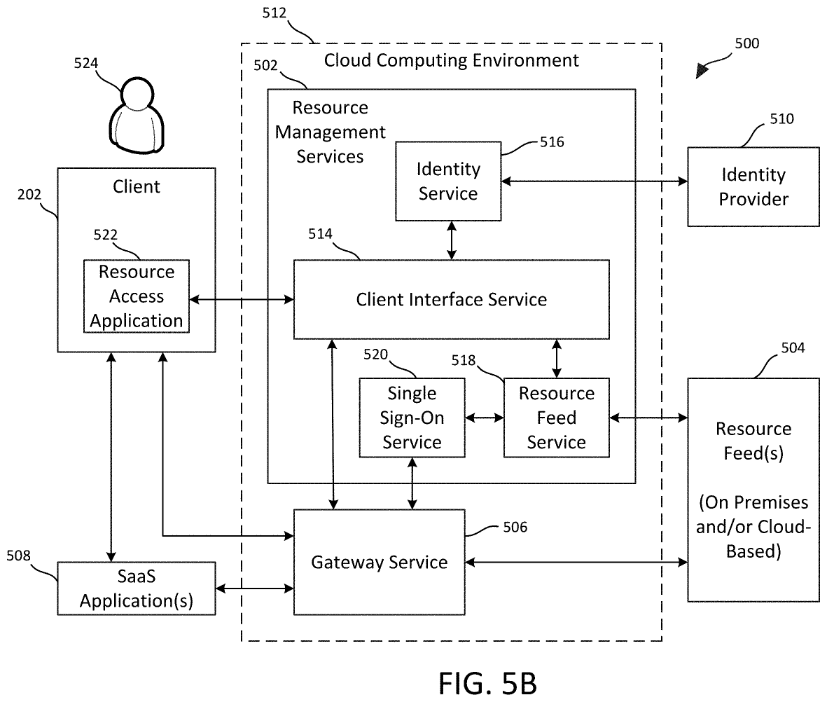

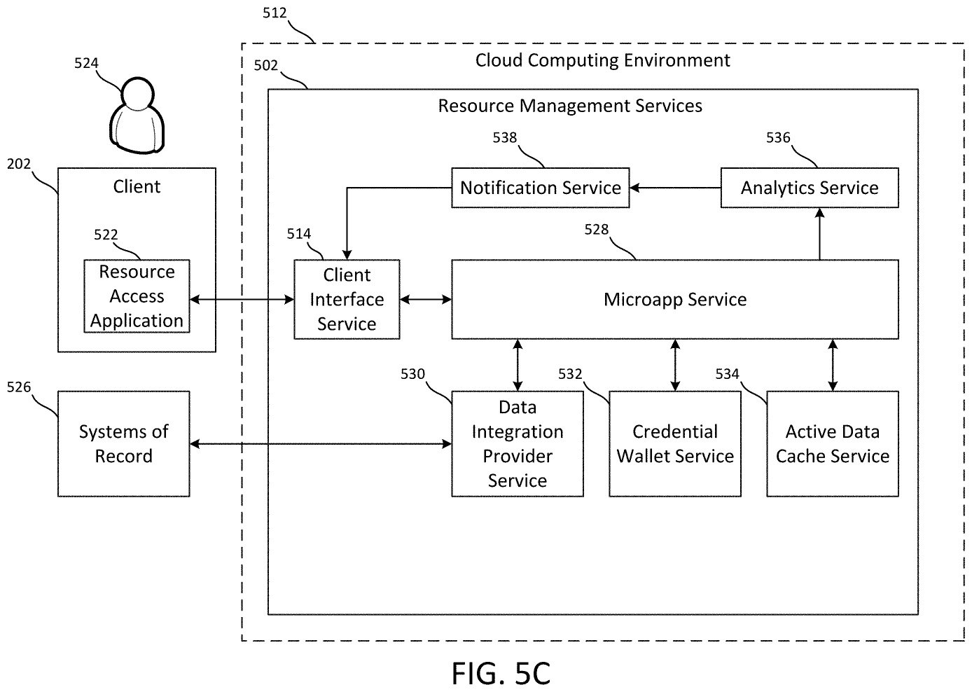

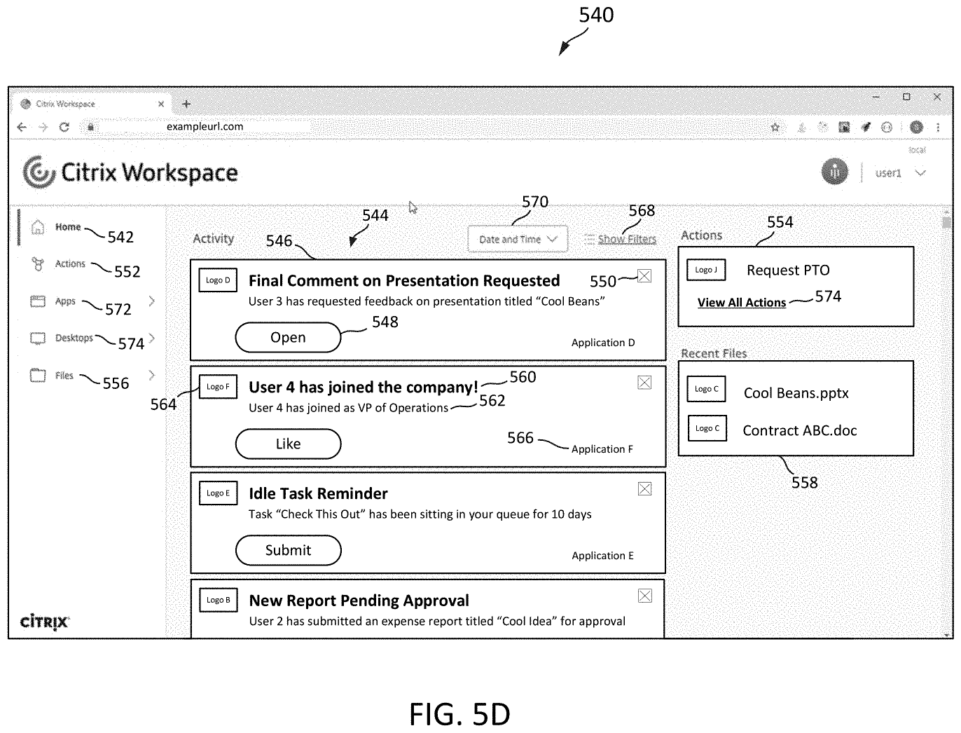

An intelligent activity feed, such as that offered by the Citrix Workspace™ family of products, provides significant benefits, as it allows a user to respond to application-specific events generated by disparate systems of record, without requiring the user to switch context and separately launch the respective applications to take actions with respect to the different events. An example of a system capable of providing such an activity feed is described in Section E below in connection with FIGS. 5A-D. In such a system, a remote computing system may be responsible for monitoring and interacting with various systems of record (e.g., SaaS applications, web applications, Windows applications, Linux applications, desktops, file repositories and/or file sharing systems, etc.) on behalf of a user operating a client device. As Section E describes (in connection with FIGS. 5C and 5D), a user 524 may operate a client device 202 so as to interact with “microapps” corresponding to particular functionalities of a variety of systems of record 526, and such microapps may, in turn, interact with the systems of record 526, e.g., via application programming interfaces (APIs) of such systems, on behalf of the user 524.

More specifically, and as described in more detail in Section E, a microapp service 528 (shown in FIG. 5C) may periodically request a sync with a data integration provider service 530, so as to cause active data to be pulled from the systems of record 526. In some implementations, for example, the microapp service 528 may retrieve encrypted service account credentials for the systems of record 526 from a credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to an analytics service 536 for processing. The analytics service 536 may create notifications (e.g., targeted scored notifications) and send such notifications to the notification service 538. The notification service 538 may store the notifications in a database to be later served in an activity feed and/or may send the notifications out immediately to the client 202 as a push notification to the user 524.

FIG. 5D, which is also described in more detail in Section E, shows how a display screen 540 presented by a resource access application 522 (shown in FIG. 5C) may appear when an intelligent activity feed feature is employed and a user 524 is logged on to the system. As shown in FIG. 5D, an activity feed 544 may be presented on the display screen 540 that includes a plurality of notifications 546 about respective events that occurred within various applications to which the user 524 has access rights. As described below (in connection with FIG. 5D), in some implementations, when presented with such an activity feed 544, the user 524 may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550.

As explained in connection with FIG. 5C below, the notifications 546 and corresponding action elements 548 may be implemented, for example, using “microapps” that can read and/or write data to systems of record 526 using application programming interface (API) functions or the like, rather than by performing full launches of the applications for such systems of record 526. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user interface elements 548, 550.

In addition to the event-driven actions accessible via the action elements 548 in the notifications 546, a user may alternatively initiate microapp actions by selecting a desired action, e.g., via a drop-down menu accessible using the “action” user interface element 552 or by selecting a desired action from a list 554 of available microapp actions. In some implementations, the various microapp actions available to the user 524 logged onto the multi-resource access system 500 may be enumerated to the resource access application 522, e.g., when the user 524 initially accesses the system 500, and the list 554 may include a subset of those available microapp actions. The available microapp actions may, for example, be organized alphabetically based on the names assigned to the actions, and the list 554 may simply include the first several (e.g., the first four) microapp actions in the alphabetical order. In other implementations, the list 554 may alternatively include a subset of the available microapp actions that were most recently or most commonly accessed by the user 524, or that are preassigned by a system administrator or based on some other criteria. The user 524 may also access a complete set of available microapp actions, in a similar manner as the “action” user interface element 552, by clicking on the “view all actions” user interface element 574.

The inventor has recognized and appreciated that circumstances may arise in which a user 524 controlling an application (referred to herein as a “user app”), e.g., Microsoft Outlook, via a client device 202 may determine it would be useful to invoke a microapp, e.g., via the microapp service 528, to take a particular action with respect to a system of record 526, e.g., Jira. For example, a user 524 reading an email may determine that it would be beneficial to use a microapp to push a task described in the email to Jira. Using the multi-resource access system 500 described in Section E, in order to access the desired microapp to take such an action, the user 524 would need to switch context from the user app (e.g., Microsoft Outlook) to access the user interface for the resource access application 522 (e.g., the display screen 540 shown in FIG. 5D). This need to switch context away from the application currently in use may result in a poor user experience, and may even discourage the user 524 from opting to use a microapp to take the desired action. As described in co-pending U.S. application Ser. No. 16/902,867, one solution to this problem is to enhance respective user apps, e.g., with add-ins or extensions, that enable the user to access user interfaces for microapps directly from such user apps. For instance, the aforementioned patent application teaches how a web browser (i.e., a type of user app) that is used to access SaaS applications may be enhanced for such a purpose, or how other types of user apps (e.g., Microsoft Word) may be enhanced in such a way. Although such a solution may provide significant benefits in many circumstances, it does not address situations in which a user is operating a user app that has not been so enhanced, such as a non-enhanced web browser or a non-enhanced local application (e.g., Microsoft Word). Although it may be theoretically possible to develop and deploy suitable enhancements for all such user apps, the administrative burden and expense of doing so would be significant. Further, the inventor has recognized and appreciated that, in existing systems, it is likewise not possible to invoke a microapp action directly from a shell application for an operating system, such as the File Explorer for Microsoft Windows (formerly called Windows Explorer).

Offered are systems and techniques that enable the invocation of microapp actions directly from virtually any user app, including an operating system shell, without needing to enhance such user apps in any way. In particular, as explained in more detail below, in some implementations, one or more processes or events outside the user app in question may be monitored to ascertain a user's intent to invoke a microapp action while operating the user app. For instance, in some implementations, the resource access application 522 (described below in connection with FIGS. 5B and 5C) may be configured to rely on messages from event handlers (e.g., UI Automation event handlers) of the operating system with which the user app is interacting to identify (A) certain conditions under which one or more microapp actions could possibly be invoked, and/or (B) particular triggering events that, when detected, enable user access to such microapp actions under the indicated conditions. In some implementations, configuration data (referred to herein as “microapp correlation data”) may be used to map particular microapp actions to corresponding conditions and triggering events. Such microapp correlation data may, for example, be pushed from the resource management services 502 to the resource access application 522, e.g., when the user 524 first authenticates to the identity service 516, and/or may be pulled from the resource management services 502 by the resource access application 522, e.g., upon launching a new resource. Several examples of possible conditions and triggering events are provided further below.

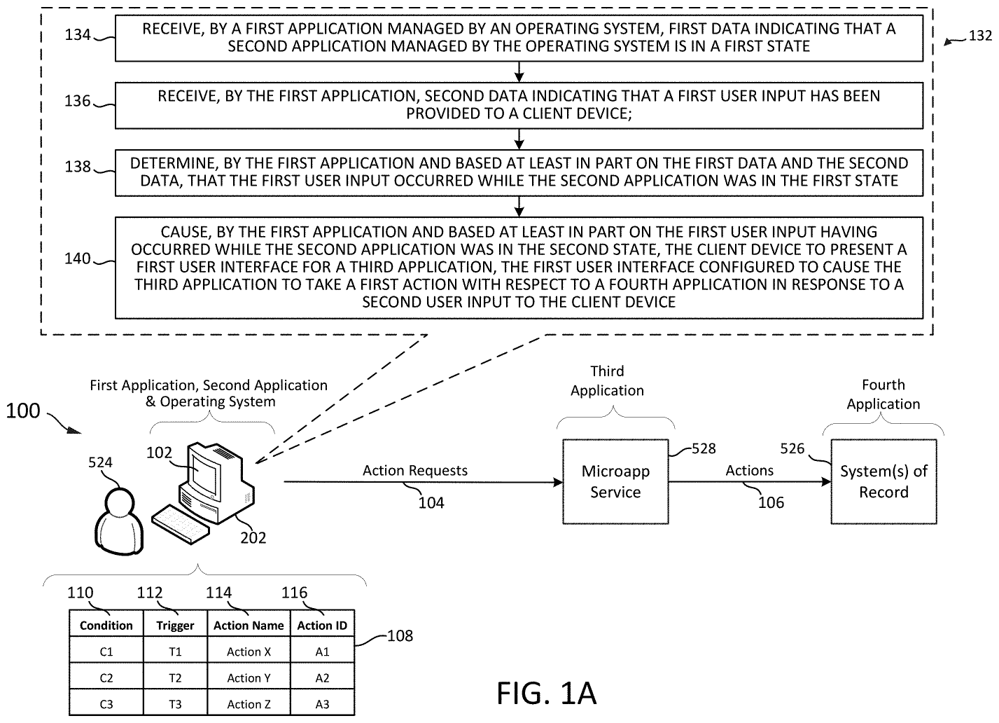

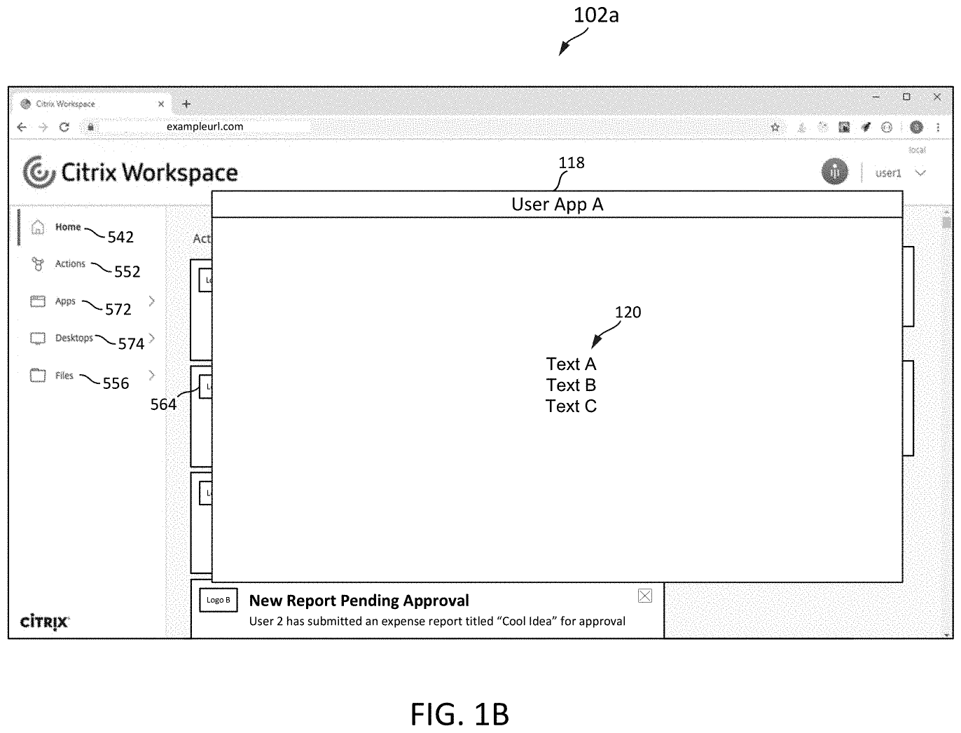

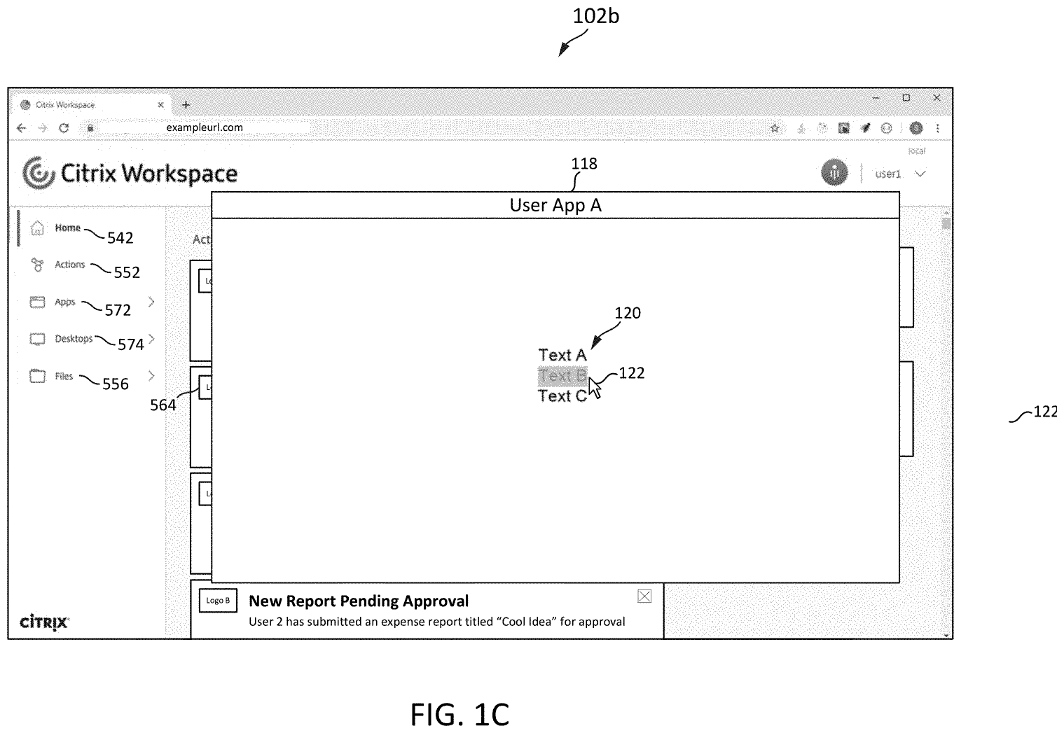

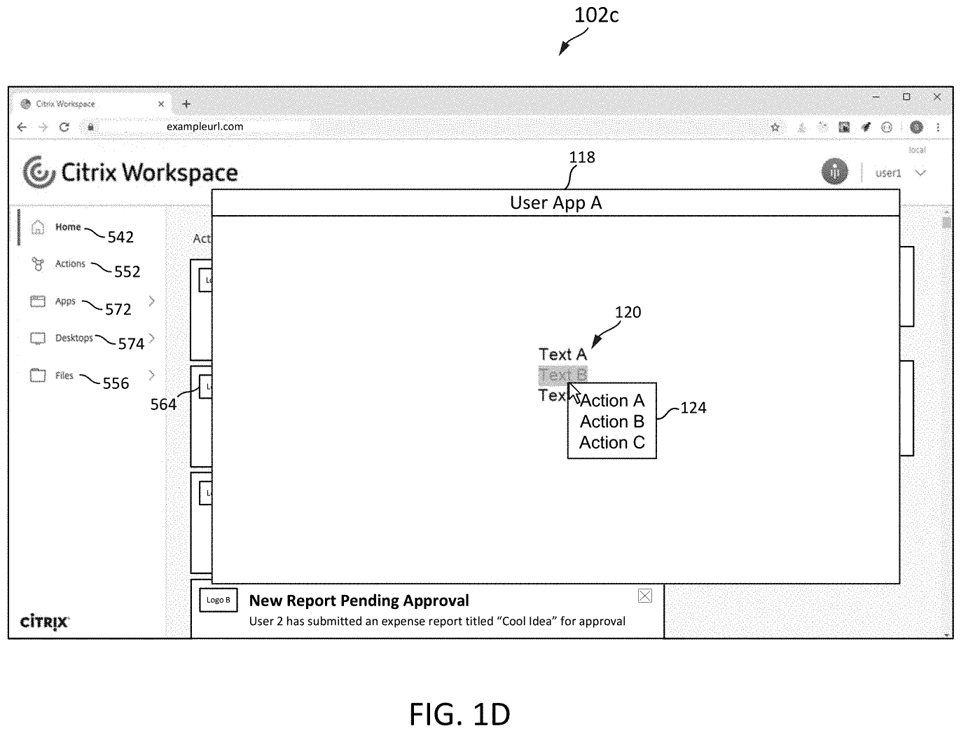

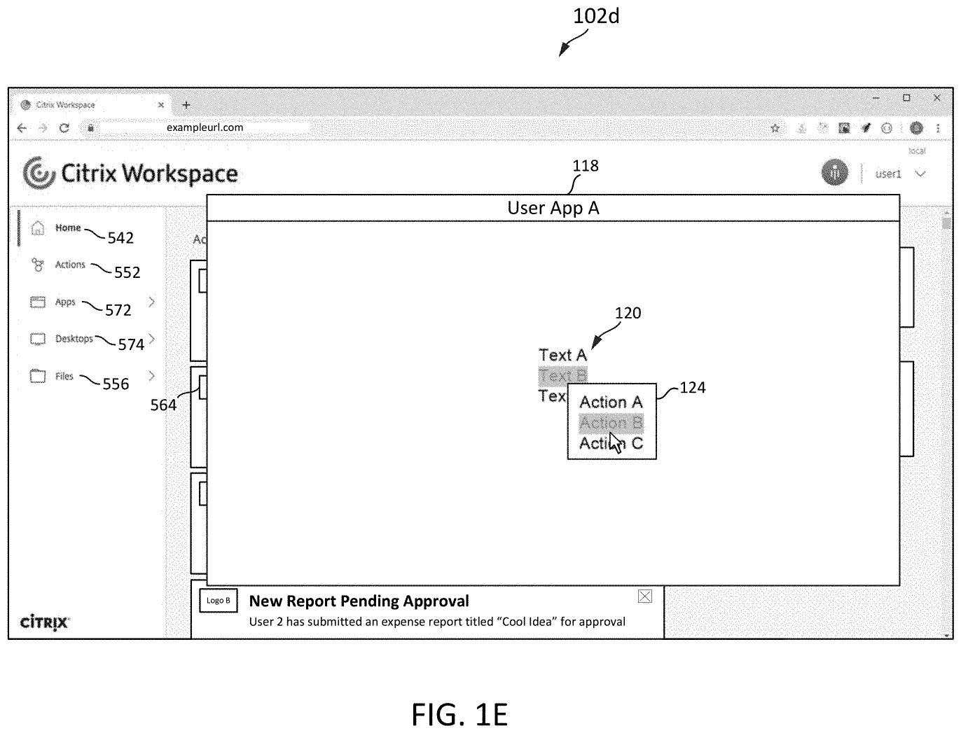

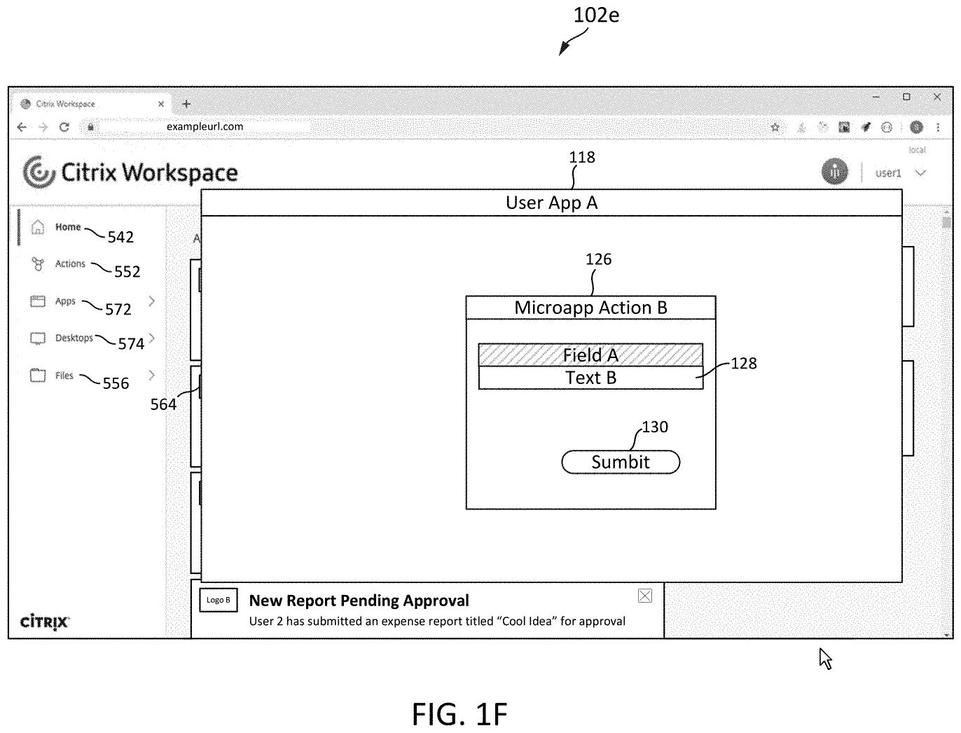

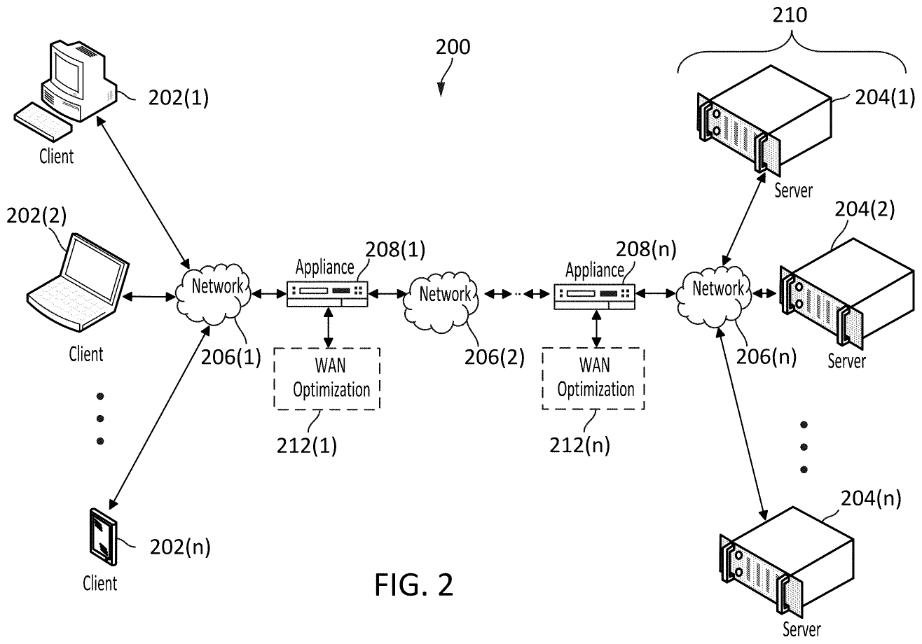

FIG. 1A shows an example system 100 in which a user 524 operating a client device 202 (examples of which are described below in connection with FIGS. 2-4) may invoke one or more microapp actions directly from a user app, without requiring the user app to be modified for that purpose. In the illustrated example, the user app (e.g., a web browser, a local application, an operating system shell, etc.) is referred to as the “second application,” the microapp configured to perform the microapp action is referred to as the “third application,” and the system of record 526 with respect to which the microapp action is to be performed is referred to as the “fourth application.” The “first application” referenced in FIG. 1A may, for example, correspond to the resource access application 522. As shown, the client device 202 may include a display screen 102 on which user interfaces for various applications accessed by the client device 202 may be presented. As indicated by an arrow 104 in FIG. 1A, upon selecting a microapp action to be invoked (as described below), the client device 202 may send an action request to the microapp service 528. And, upon receiving such an action request, a microapp of the microapp service 528 may, as indicated by an arrow 106 in FIG. 1A, take one or more steps to take the requested action with respect to a particular system of record 526 on behalf of the user 524 (e.g., via one or more APIs of the system of record 526).

As explained in more detail below, in some implementations, the client device 202 may use microapp correlation data 108 (shown in the lower, left-hand corner of FIG. 1A) to correlate particular microapp actions with certain conditions and triggering events so as to enable the user 524 to access such microapp actions while the user is operating one or more user apps (e.g., the second application reference in FIG. 1A). As indicated, in some implementations, the microapp correlation data 108 may include “condition” entries 110, “trigger” entries 112, “action name” entries 114 and “action ID” entries 116. Such microapp correlation data 108 may be received, for example, from the resource feed service 518, or from another component of the resource management services 502 described below in connection with FIGS. 5-C.

FIGS. 1B-F show example instantiations of the display screen 102, labeled with reference numerals 102a-e, respectively, illustrating how the system 100 shown in FIG. 1A may enable the user 524 to access one or more microapp actions directly from a particular user app, i.e., “User App A” in the illustrated example, without requiring any enhancements to that user app. The “User App A” shown in FIGS. 1B-F may, for example, be a web browser (used to access a SaaS application or otherwise), a local application (e.g., Word or Outlook), an Independent Computing Architecture (ICA) client application used to receive one or more delivered applications or desktops (e.g., via a Citrix Virtual Apps and Desktops™ service), a client application used to access a file sharing system (e.g., Citrix ShareFile®), a shell of an operating system (e.g., File Explorer), etc.

As shown in FIG. 1B, the display screen 102a may present a window 118 or other user interface for User App A. In some circumstances, the window 118 may, for example, have been displayed in response to the user selecting User App A from a list of applications presented when the user clicked on the “Apps” user interface element 572. In other circumstances, User App A may have been accessed in other ways, such as by taking one or more steps independent of the resource access application 522 to launch or otherwise access the user app. In some implementations, for example, the user may have simply selected an icon for the user app on the user's desktop, thus causing User App A to launch. As shown, the window 118 may include content 120, such as text, file icons, etc.

As shown in FIG. 1C, the user 524 may cause a portion of the displayed content 120 to be selected, e.g., by moving a cursor 122 while clicking and holding a left mouse button, by hovering over or clicking on a file icon, etc. In the illustrated example, the user 524 has selected the text “Text B” within the window 118. The content that is so selected may serve any of a number of purposes in various implementations. As one example, as explained in more detail below in connection with FIG. 1D, in some implementations, the first application (e.g., the resource access application 522) may use the selected content to determine whether one or more conditions specified in the microapp correlation data 108, e.g., as “condition” entries 110, are satisfied. For instance, a “condition” entry 110 may indicate that selected text needs to contain one or keywords, such as “PTO,” “time off,” “vacation,” etc., in order for a user interface element for a “submit PTO request” microapp to be presented as selectable option, e.g., within a first user interface window 124 (shown in FIG. 1D), in response to the user 524 providing a particular “trigger” input, e.g., a right-click. As another example, as explained in more detail below in connection with FIG. 1F, the first application (e.g., the resource access application 522) may use the selected content to populate one or more fields, e.g., a fillable field 128 of a user interface window 126 (shown in FIG. 1F), for a microapp.

As shown in FIG. 1D, the user 524 may cause a first user interface window 124 that includes list of available microapp actions to be presented by providing a particular type of input to the client device (e.g., by right-clicking a mouse). In the illustrated example, the first user interface window 124 identifies three available microapp actions, including “Action A,” “Action B,” and “Action C.” As explained in more detail below, the first user interface window 124 may be generated and presented by an application (e.g., the first application referenced in FIG. 1A) other than User App A. For example, the first application (e.g., the resource access application 522) may present the first user interface window 124 as an overlay window on top of the window 118 for User App A.

In some implementations, the determination of the microapp actions that are to be identified in the first user interface window 124 may be made, e.g., by the first application referenced in FIG. 1A, based on the microapp correlation data 108. For example, in some implementations, the text of the items within the first user interface window 124 may correspond to respective “action name” entries 114 in the microapp correlation data 108, and the first application (e.g., the resource access application 522) may cause respective microapp actions to be identified in the first user interface window 124 only if the first application determines that both (A) the condition indicated in the “condition” entry 110 for the item is met, and (B) the triggering event indicated in the “trigger” entry 112 for the microapp action has occurred. For respective microapp actions, the respective “condition” entries 110 may specify one or more potential operational states of one or more user apps. As just a few examples, the operational state(s) specified by respective “condition” entries 110 may include one or more of (A) that a foreground application is executing a particular process (e.g., Winword), (B) that a foreground window has a particular title (e.g., Adobe), (C) that a browser in a foreground window is pointed to a particular URL domain (e.g., trello.com), (D) that selected text within a foreground window (e.g., as described in connection with FIG. 1C) contains or matches a particular string, (E) that a selected and/or opened file is of a particular type (e.g., .docx), and so on. The “trigger” entries 112 may specify particular user input types, e.g., a right-click, one or more shortcut keys, etc., that are to trigger the first application (e.g., the resource access application 522) to generate and present the first user interface window 124 including the corresponding action names when the indicated condition is satisfied.

As shown in FIG. 1E, the user 524 may select one of the action names presented in the first user interface window 124 presented by the first application (e.g., the resource access application 522), such as by hovering the cursor over the action name and left-clicking the mouse. In the illustrated example, the user has selected the action name “Action B.”

As shown in FIG. 1F, in response to the user 524 selecting “Action B” within the first user interface window 124, the first application (e.g., the resource access application 522) may cause the client device 202 to present a second user interface window 126 for that microapp action, i.e., “Microapp Action B.” Similar to the first user interface window 124 (shown in FIGS. 1D and 1E), the first application (e.g., the resource access application 522) may present the second user interface window 126 as an overlay window on top of the window 118 for User App A. In some implementations, the first application (e.g., the resource access application 522) may retrieve the content and UI controls of the second user interface window 126 from a remote source, e.g., from the microapp service 528. For example, in some implementations, the “action ID” entry 116 corresponding to the selected action name in the microapp correlation data 108, may be used by the first application (e.g., the resource access application 522) to identify and/or retrieve the content and UI controls for the second user interface window 126 from the microapp service 528. In other implementations, the action ID entries 116 may themselves include the content and UI controls, or point to locally stored content and UI controls, for second user interface windows 126 for particular microapp actions.

As also shown in FIG. 1F, in some implementations, the first application (e.g., the resource access application 522) may further cause the second user interface window 126 to include, e.g., within a fillable field 128 of the second user interface window 126, the content in the window 118 of User App A that was previously selected, e.g., as shown in FIG. 1C. In the illustrated example, the first application (e.g., the resource access application 522) has caused the selected text “Text B” to appear within the fillable field 128 for the field “Field A.” Upon selection of a user interface element 130, e.g., a “submit” button, in the second user interface window 126, the first application (e.g., the resource access application 522) may send an action request (e.g., as indicated by the arrow 104 in FIG. 1A) to the microapp service 528, instructing the microapp service 528 to take the indicated action with respect to a system of record 526, e.g., as indicated by the arrow 106 in FIG. 1A. In at least some circumstances, to execute the action, the system of record 526 may use the selected content from the window 118 of user app that the first application (e.g., the resource access application 522) had inserted into the second user interface window 126.

Referring again to FIG. 1D, in some implementations, rather than presenting the first user interface window 124 (including a list of available actions) in response to detecting a trigger input while a user app is in a particular state (e.g., as specified by a “condition” entry 110 and corresponding “trigger” entry 112 in the microapp correlation data 108), the first application (e.g., the resource access application 522) may instead immediately present a second user interface window 126 (e.g., as shown in FIG. 1F) for a particular microapp action. For instance, in some such implementations, different keyboard shortcuts may be specified to directly invoke respective microapp actions, such as by designating “ALT-J” as a trigger input for a “Send task to Jira” microapp action, “ALT-C” as a trigger input for “Submit expense report to Concur,” etc.

Although not illustrated in FIGS. 1A-F, in some implementations, after taking the requested action with respect to a system of record 526, the microapp service 528 may receive data indicative of a result of the executed action from the system of record 526, and may pass that data to the first application (e.g., the resource access application 522) on the client device 202. As described in more detail in second F below, in some implementations, the first application (e.g., the resource access application 522) may take one or more additional steps (e.g., using UI Automation APIs and/or hooks) to cause the returned data to be input into the second application (e.g., User App A) or a user interface for the second app, e.g., the window 118. Further, although not shown in FIG. 1A, it should be appreciated that, in some implementations, the microapp correlation data 108 may additionally include entries specifying the additional step(s) that are to be taken by the first application (e.g., the resource access application 522) upon receiving such result data from the third application (e.g., a microapp of the microapp service 528).

FIG. 1A additionally shows an example routine 132 that may be performed by the first application (e.g., the resource access application 522) in accordance with some aspects of the present disclosure. As shown in FIG. 1A, at a step 134 of the routine 132, a first application (e.g., the resource access application 522) may receive first data indicating that a second application (e.g., User App A) is in a first state. As noted, the first application (e.g., the resource access application 522) and the second application (e.g., User App A) may both be managed by the same operating system. In some implementations, the first data may be sent from the operating system to the first application (e.g., the resource access application 522) because the first application (e.g., the resource access application 522) registered one or more event handlers (e.g., UI Automation event handlers) with the operating system of the client device 202. In some implementations, such event handlers may be capable of monitoring the various conditions identified by the “condition” entries 110 of the microapp correlation data 108. Accordingly, the first data returned by such event handlers may indicate whether a first application (e.g., User App A) with which the user 524 is interacting and/or that is present in a foreground window of the client device 202, satisfies one or more of those conditions.

As a step 136 of the routine 132, the first application (e.g., the resource access application 522) may receive second data indicating that a first user input (e.g., a right click, Alt-J, etc.) has been provided to the client device 202. Like the first data reference in the step 134, in some implementation, the second data may be sent from the operating system to the first application (e.g., the resource access application 522) because the first application (e.g., the resource access application 522) registered one or more event handlers (e.g., UI Automation event handlers) with the operating system of the client device 202. In some implementations, such event handlers may be capable of monitoring the various trigger inputs identified by the “trigger” entries 112 of the microapp correlation data 108. Accordingly, the second data returned by such event handlers may indicate whether user inputs to the client device 202 correspond to one or more of those triggers. In some implementations, the first application (e.g., the resource access application 522) may (A) register event handlers for the respective trigger inputs (e.g., as specified by the “trigger” entries 112 in the microapp correlation data 108) in response to determining that the corresponding conditions (e.g., as specified by the “condition” entries 110 in the microapp correlation data 108) are satisfied, and (B) may de-registered those event handlers in response to determining (e.g., based on data received from one or more other event handlers, as described above) that the corresponding condition is no longer satisfied.

At a step 138 of the routine 132, the first application (e.g., the resource access application 522) may determine, based at least in part on the first data (received per the step 134) and the second data (received per the step 136), that the first user input (e.g., a right click, Alt-J, etc.) occurred while the second application (e.g., User App A) was in the first state, e.g., was present in the foreground window of the client device 202.

At a step 140 of the routine 132, the first application (e.g., the resource access application 522) may, based at least in part on the first user input (e.g., a right click, Alt-J, etc.) having occurred while the second application (e.g., User App A) was in the second state (e.g., was present in the foreground window of the client device 202), cause the client device 202 to present a first user interface (e.g., the second user interface window 126 shown in FIG. 1F) for a third application (e.g., a microapp of the microapp service 528), the first user interface (e.g., the second user interface window 126 shown in FIG. 1F) configured to cause the third application (e.g., a microapp of the microapp service 528) to take a first action with respect to a fourth application (e.g., a system of record 526) in response to a second user input (e.g., selection of the user interface element 130 shown in FIG. 1F) to the client device 202.

Additional details and example implementations of embodiments of the present disclosure are set forth below in Section F, following a description of example systems and network environments in which such embodiments may be deployed.

B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+an organization.

C. Computing Environment

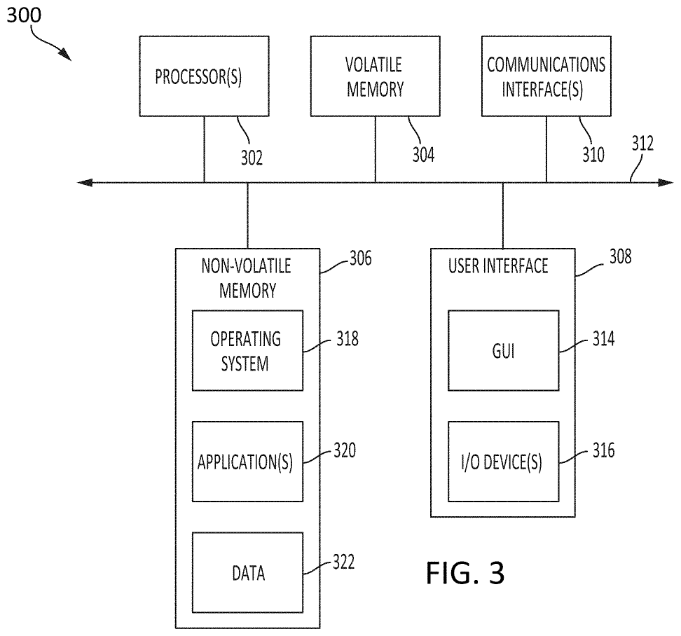

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

D. Systems and Methods for Delivering Shared Resources Using a Cloud Computing Environment

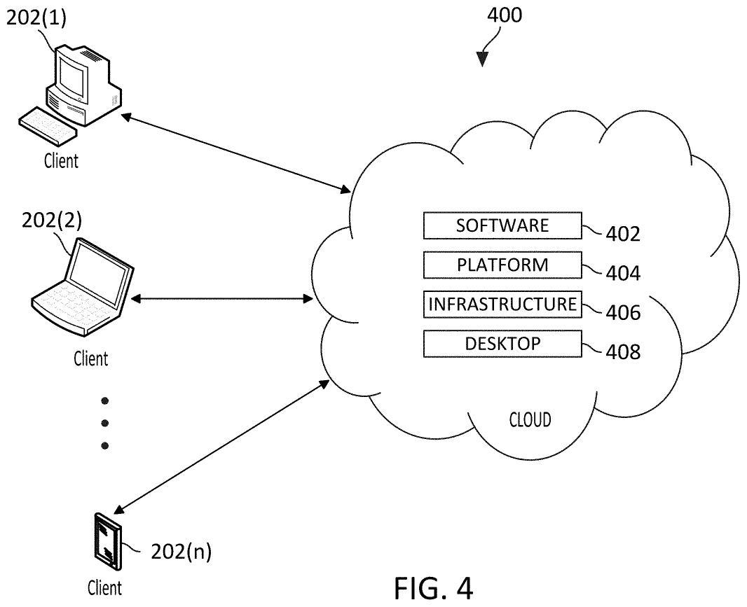

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS platforms include AMAZON WEB SERVICES provided by Amazon.com, Inc., of Seattle, Wash., Azure IaaS provided by Microsoft Corporation or Redmond, Wash., RACKSPACE CLOUD provided by Rackspace US, Inc., of San Antonio, Tex., Google Compute Engine provided by Google Inc. of Mountain View, Calif., and RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile® from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., username and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., ShareFile, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource access application 522 is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and XML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system of record to which the notification 546 corresponds, thus helping the user understand the proper context with which to decide how best to respond to the notification 546. In some implementations, one or more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D), a “relevancy” mode (not illustrated) may be selected (e.g., using the element 570) in which the notifications may be sorted based on relevancy scores assigned to them by the analytics service 536, and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp.

In addition to the event-driven actions accessible via the action elements 548 in the notifications 546, a user may alternatively initiate microapp actions by selecting a desired action, e.g., via a drop-down menu accessible using the “action” user interface element 552 or by selecting a desired action from a list 554 of available microapp actions. In some implementations, the various microapp actions available to the user 524 logged onto the multi-resource access system 500 may be enumerated to the resource access application 522, e.g., when the user 524 initially accesses the system 500, and the list 554 may include a subset of those available microapp actions. The available microapp actions may, for example, be organized alphabetically based on the names assigned to the actions, and the list 554 may simply include the first several (e.g., the first four) microapp actions in the alphabetical order. In other implementations, the list 554 may alternatively include a subset of the available microapp actions that were most recently or most commonly accessed by the user 524, or that are preassigned by a system administrator or based on some other criteria. The user 524 may also access a complete set of available microapp actions, in a similar manner as the “action” user interface element 552, by clicking on the “view all actions” user interface element 574.

As shown, additional resources may also be accessed through the screen 540 by clicking on or otherwise selecting one or more other user interface elements that may be presented on the screen. For example, in some embodiments, the user may also access files (e.g., via a Citrix ShareFile® platform) by selecting a desired file, e.g., via a drop-down menu accessible using the “files” user interface element 556 or by selecting a desired file from a list 558 of recently and/or commonly used files. Further, in some embodiments, one or more applications may additionally or alternatively be accessible (e.g., via a Citrix Virtual Apps and Desktops™ service) by clicking on or otherwise selecting an “apps” user interface element 572 to reveal a list of accessible applications or by selecting a desired application from a list (not shown in FIG. 5D but similar to the list 558) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user interface element 574 to reveal a list of accessible desktops or by or by selecting a desired desktop from a list (not shown in FIG. 5D but similar to the list 558) of recently and/or commonly used desktops.

The activity feed shown in FIG. 5D provides significant benefits, as it allows a user to respond to application-specific events generated by disparate systems of record without needing to navigate to, launch, and interface with multiple different native applications.

F. Detailed Description of Example Embodiments of a System for Enabling Microapp Access Based on Determined Application States and User-Initiated Triggering Events

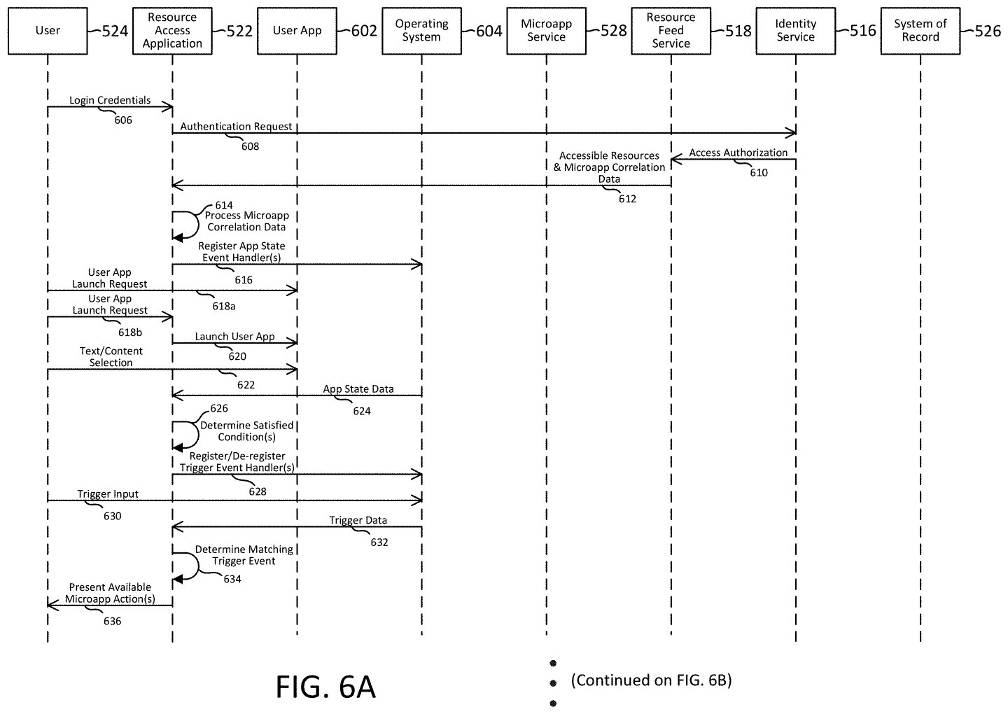

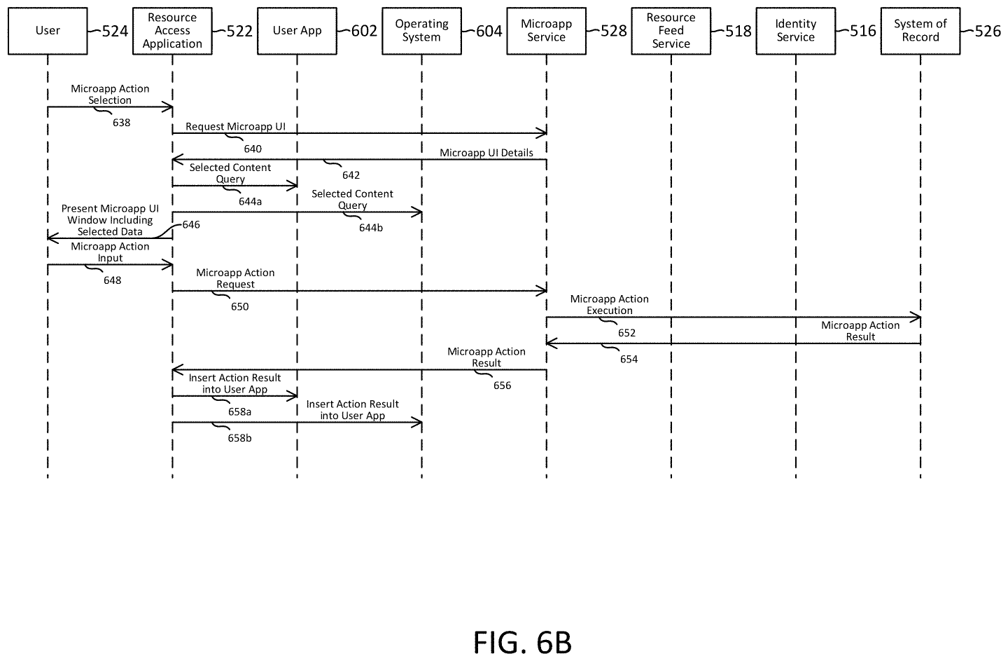

Section A introduced systems and techniques for enabling the invocation of microapp actions directly from virtually any user app, including an operating system shell, without needing to enhance such a user app in any way. In particular, as explained in Section A, in some implementations, one or more processes or events outside the user app in question (e.g., User App A) may be monitored to ascertain a user's intent to invoke a microapp action while operating the user app. The sequence diagram shown in FIGS. 6A and 6B illustrates messages that may be exchanged amongst the resource access application 522, a user app 602 (e.g., User App A described in Section A) and an operating system 604 of the client device 202, as well as other components of the multi-resource access system 500 described in Section E, to enable certain aspects of the functionality described in Section A.

As Section A explains, in some implementations, an operating system of a client device 202 may manage the execution of a resource access application 522 in addition to one or more user apps, e.g., a web browser (used to access a SaaS application or otherwise), a local application (e.g., Word or Outlook), an Independent Computing Architecture (ICA) client application used to receive one or more delivered applications or desktops (e.g., via a Citrix Virtual Apps and Desktops™ service), a client application used to access a file sharing system (e.g., Citrix ShareFile®), a shell of an operating system (e.g., File Explorer), etc. In addition, as also described in Section A, the resource access application 522 may be configured to rely on messages from event handlers (e.g., UI Automation event handlers) of the operating system with which the user app is interacting to identify (A) certain conditions under which one or more microapp actions could possibly be invoked, and/or (B) particular triggering events that, when detected, are to enable user access to such microapp actions under the indicated conditions. Using such data, the system may present the user 524 with one or more options for invoking microapp actions, on demand, directly from the user app in question (e.g., User App A described in connection with FIGS. 1B-F). The steps shown in the first portion of the illustrated sequence diagram, i.e., in FIG. 6A, enable such functionality. As explained further below, the second portion of the illustrated sequence diagram, i.e., in FIG. 6B, shows interactions that may take place between various components of the multi-resource access system 500 to process microapp actions the user 524 opts to invoke while operating the user app in question (e.g., User App A described in connection with FIGS. 1B-F).

As shown in FIG. 6A, a user 524 may input (606) login credentials (e.g., a user name and password) to the resource assess application 522. After receiving the user's login credentials, the resource access application 522 may communicate (608) an authentication request to the identity service 516 (described in connection with FIG. 5B). Upon determining the logon credentials are valid, the identity service 516 may, among other things, notify (610) the resource feed service 518 (described in connection with FIG. 5B) that the user 524 is authorized to use the multi-resource access system 500. As described in connection with FIG. 5B, upon receiving the access authorization notification from the identity service 516, the resource feed service 518 may aggregate information concerning the various systems of record 526 the user is authorized to access, and may send (612) information identifying those accessible resources to the resource access application 522 (e.g., via the client interface service 514 shown in FIG. 5B), thus enabling the resource access application 522 to present a list of available resources on a user interface of the client device 202 (e.g., as described in connection with FIG. 5D). As shown, in some implementations, the resource feed service 518 may also send (612) some or all of the microapp correlation data 108 (an example of which is shown in FIG. 1A) to the resource access application 522, together with the information identifying the resources that are to be made accessible via the resource access application 522.

The resource access application 522 may process (614) the received microapp correlation data 108 to configure the resource access application 522 to take appropriate steps to determine when certain conditions with respect to user apps are met, to determine when certain trigger events have been detected, and to enable the presentation of user interfaces for particular microapps when the specified trigger events have occurred under the indicated conditions. As explained below in connection with steps 616 and 628, for example, in some implementations, the microapp correlation data 108 may configure the resource access application 522 to register event handlers with the operating system 604 for such purposes. Further, in some implementations, the microapp correlation data 108 may also configure the resource access application 522 to take one or more steps to identify content that has been selected within a particular user app (e.g., per step 622, as described below). For example, as explained in more detail below in connection with steps 644a and 644b (shown in FIG. 6B), in some implementations, the microapp correlation data 108 may configure the resource access application 522 to query the user app 602 and/or the operating system 604 to identify content that was selected within a given user app (e.g., User App A described in connection with FIGS. 1B-F) when a triggering event was detected, so that such content may be inserted into a user interface for the microapp, as described below in connection with the step 646. And still further, as noted previously, in some implementations, the resource access application 522 may additionally process the microapp correlation data 108 to configure the resource access application 522 to insert result data generated by a system of record 526 into the user app for which a microapp user interface was used to take an action with respect to that system of record 526. For example, as explained in more detail below in connection with steps 658a and 658b (shown in FIG. 6B), in some implementations, the microapp correlation data 108 may configure the resource access application 522 to instruct the user app 602 and/or the operating system 604 to insert such result data into the user app 602 in an appropriate way.

Referring again to FIG. 6A, the resource access application 522 may register (616) one or more event handlers with the operating system 604 for the purpose of ascertaining whether one or more of the conditions specified in the microapp correlation data 108, e.g., by “condition” entries 110, are satisfied. For example, in some implementations, the resource access application 522 may register one or more UI Automation event handlers with the operating system 604 so as to cause the operating system 604 to return data sufficient for the resource access application 522 to determine whether a state of a user app being worked on in a foreground window of the client device 202 meets the respective conditions specified in the microapp correlation data 108. Examples of state information that may be acquired by event handlers for this purpose include (A) an indication that a foreground application is executing a particular process (e.g., Winword), (B) an indication that a foreground window has a particular title (e.g., Adobe), (C) an indication that a browser in a foreground window is pointed to a particular URL domain (e.g., trello.com), (D) an indication that selected text within a foreground application (e.g., per step 622, as described below) contains or matches a particular string, (E) an indication that a selected and/or opened file is of a particular type (e.g., .docx), and so on.

As shown, in some implementations, the user 524 provide (618a) a launch request directly to the user app 602, such as by double clicking on a file on the user's desktop, selecting an executable file for the user app 602 from a “start” menu of the client device 202, or otherwise. In such implementations, the user app 602 may thus be launched on the client device 202 without involvement by the resource access application 522. Alternatively, in some implementations, the user 524 may input (618b) a request to the resource access application 522 to launch a particular user app, and the resource access application 522 may, in turn, trigger (620) the launching of the user app 602. For instance, the user 524 may identify one or the applications managed by the multi-resource access system 500, e.g., by clicking on the “Apps” user interface element 572 shown in FIG. 5D to reveal a list of accessible applications, and may select a user interface element corresponding to a desired application to instruct the resource access application 522 to cause that application to be launched, e.g., using any of the techniques described above for launching different types of user apps. In any event, the user app 602 and the resource access application 522 may be concurrently running on the client device 202 after the user app 602 has been launched.

Once the user app 602 has been launched, the user 524 may interact (622) with the user app 602 to select content within a user interface of the user app 602 (e.g., within the window 118 for User App A described above in connection with FIGS. 1B-F). As one example, the user 524 may select a text string by moving a cursor 122 while clicking and holding a left mouse button, e.g., as described above in connection with FIG. 1C. As another example, the user 524 may select an icon or other identifier of a file, e.g., within an operating system shell, by using a mouse to hover over or click on such an icon/identifier.

Based on the event handlers registered per the step 616, the operating system 604 may send (624) to the resource access application 522 notifications of events that are detected by those event handlers, which notifications may indicate information concerning a state of the user app 602 that is present in the foreground window of the client device 202, as discussed above.

The resource access application 522 may process (626) the event notifications received from the operating system (e.g., per the step 624) to determine, based on the indicated state of the application represented in the foreground window, whether one or more of the conditions specified in the microapp correlation data 108, e.g., per the “condition” entries 110, are satisfied for that application.

For condition(s) that the resource access application 522 determines are satisfied (per the step 626), the resource access application 522 may register (628) one or more event handlers, e.g., mouse and/or keyboard handlers, with the operating system 604 for the purpose of ascertaining whether the trigger events specified in the microapp correlation data 108 for the satisfied condition(s) have occurred. For condition(s) that the resource access application 522 determines are not satisfied (per the step 626), the resource access application 522 may also de-register (628) one or more event handlers, e.g., keyboard and/or mouse handlers, that are no longer needed to detect trigger inputs corresponding to those condition(s).

The operating system 604 may detect (630) a trigger input provided by the user 524, e.g., via a mouse or a keyboard. For example, the user 524, while interacting with a user interface for the user app 602 (e.g., the window 118 for User App A described above in connection with FIGS. 1B-F), may have right-clicked on a mouse, or provided another input that was detected by event handlers, e.g., mouse and/or keyboard handlers, that were registered per the step 628. Upon detecting the trigger input provided by the user 524, the operating system 604 may send (632) data indicative of the detected trigger event to the resource access application 522. Upon receiving the trigger data from a registered event handler (per the step 632), the resource access application 522 may determine (634) whether the received trigger data is indicative of one or more trigger events specified in the microapp correlation data 108, e.g., per “trigger” entries 112, for one or more conditions, e.g., per “condition” entries 110, that were determined to be satisfied (per the step 626).

If, at the step 634, the resource access application 522 determines that the received trigger data indicates that a trigger event (e.g., a right mouse click) corresponding to one or more satisfied conditions (e.g., the title of the foreground window being “Adobe”) has occurred, the resource access application 522 may cause the client device 202 to present (636) a user interface, e.g., the first user interface window 124 shown in FIG. 1D, identifying one or more microapp actions that are available for use. As described above in connection with FIG. 1D, in some implementations, the resource access application 522 may present (636) such a user interface as an overlay window on top of the window of the foreground application with which the user 524 is interacting, e.g., on top of the window 118 for User App A, as shown in FIG. 1D. In some implementations, the resource access application 522 may include within the user interface that is so presented, e.g., the first user interface window 124, selectable user interface elements for respective ones of the actions names identified in the microapp correlation data 108, e.g., per “action name” entries 114, for which both (A) the corresponding condition, e.g., per a “condition” entry 110, is satisfied, and (B) the corresponding trigger event, e.g., per a “trigger” entry 112, has occurred.

Referring now to FIG. 6B, the user 524 may provide (638) an input to the resource access application 522 indicating a selection of one of the microapp actions identified in the user interface presented per the step 636, e.g., by selecting “Action B” within the first user interface window 124, as shown in FIG. 1E.

Upon receiving an input selecting a microapp action, the resource access application 522 may send (640) to the microapp service 528 a request for content and UI controls for a user interface window for the selected microapp action, e.g., the second user interface window 126 shown in FIG. 1F. As shown, in response to the request, the microapp service 528 may return (642) the requested content and UI controls for the user interface window.

In response to receiving the content and UI controls for the user interface window (per the step 642), the resource access application may take one or more steps to determine content that may have been selected within the user interface of the user app 602, e.g., within the window 118 of User App A, as shown in FIGS. 1B and 1C, at the time the user provided the trigger input (per the step 630), e.g., as illustrated in FIG. 1D. As noted above, in some implementations, the step(s) that are to be taken by the resource access application 522 for this purpose may be determined, at least in part, based on the microapp correlation data 108. For instance, in some implementations, the microapp correlation data 108 may include one or entries (not shown in FIG. 1A) that specify such steps and/or point to information identifying them. In some implementations, the step(s) that are to be taken to identify content selected within the user app 602 may additionally or alternatively be specified, at least in part, by the data received from the microapp service (e.g., per the step 642) corresponding to the content and UI controls for the microapp user interface that is to be presented.

In any event, as illustrated, in some circumstances, the resource access application 522 may send (644a) a query to the user app 602 to determine content that may have been selected within the user interface of the user app 602, e.g., within the window 118 of User App A, as shown in FIGS. 1B and 1C, at the time the user provided the trigger input (per the step 630), e.g., as illustrated in FIG. 1D. For instance, the resource access application 522 may make an API call to the user app 602 to determine such selected content. As an example, Microsoft Office applications may have APIs that can be used for this purpose.

Additionally or alternatively, as also illustrated, in some circumstances, the resource access application 522 may send (644b) a query to the operating system 604 to determine content that may have been selected within the user interface of the user app 602, e.g., within the window 118 of User App A, as shown in FIGS. 1B and 1C, at the time the user provided the trigger input (per the step 630), e.g., as illustrated in FIG. 1D. For instance, the resource access application 522 may make UI Automation API calls to fetch such selected content from the operating system 604. In some circumstances, e.g., when selected content cannot be determined using UI Automation APIs, the resource access application 522 may instead rely on one or more operating system hooks (e.g., implemented per the step 644b) to determine user actions indicative of the selection of content, e.g., clicking and holding a left mouse button while dragging the cursor 122 (e.g., as shown in FIG. 1C), and based on that information may retrieve the contents of a portion of the screen buffer corresponding to the selected region within the window of the user app 602 (e.g., the window 118 shown in FIG. 1C). In such circumstances, the resource access application 522 may perform optical character recognition (OCR) on the image data obtained from the screen buffer to determine a text string represented in the selected region. Such a technique may be useful, for example, when the user app 602 is a browser and the selected content is text that is not represented within the UI Automation information available from the operating system 604.

In any event, as shown in FIG. 6B, the resource access application 522 may present (646) a user interface window, e.g., the second user interface window 126 shown in FIG. 1F, for the selected microapp action. As indicated, when the resource access application 522 has determined content that was selected within the user interface for the user app 602 (e.g., per the step 644a and/or the step 644b, as discussed above), the resource access application 522 may insert that content into an appropriate location within the user interface window. In the circumstance shown in FIG. 1F, for example, the resource access application 522 may have inserted the selected content “Text B” into the Tillable field 128 within the second user interface window 126.

As shown in FIG. 6B, upon receiving (648) an input from the user 524 indicating that the selected microapp action is to be taken, e.g., in response to the user 524 selecting the user interface element 130 within the second user interface window 126 shown in FIG. 1F, the resource access application 522 may send (650) a message to the microapp service 528 requesting that the indicated action be taken with respect to the system of record 526. In some implementations, the user 524 may be permitted to modify the content that was inserted into the user interface window for the selected microapp action prior to providing the input (per the step 648) indicating that the selected microapp action is to be taken.

Upon receiving the “action request” message from the resource access application 522 (per the step 650), the resource access application 522 may take the requested action with the system of record 526 on behalf of the user 524, e.g., by retrieving access credentials for the user 524 and making one or more API calls to the system of record 526 using those credentials. In some circumstances, some or all of the content that was inserted into the user interface for the microapp action (per the step 646) may be used take the action with respect to the system of record 526.

Upon completing the requested action, the system of record 526 may send (654) a message to the microapp service 528 that is indicative of a result of taking the requested action. For instance, upon completing the action, the system of record 526 may have generated a link or other information indicative of data that was stored or is otherwise available as a result of completing the action. The message sent (654) to the microapp service 528 may include that link or other information corresponding to the determined result.

Upon receiving such a result from the system of record 526, the microapp service 528 may send (656) a message indicative of the result to the resource access application 522. Upon receiving the result data from the microapp service 528, the resource access application 522 may take one or more actions to insert data indicative of the result into the user app 602 and/or the currently presented user interface window for the user app 602, e.g., the window 118 of User App A shown in FIGS. 1B-F. As shown, in some circumstances, the resource access application 522 may send (658a) a request to the user app 602, e.g., by calling one or more APIs of the user app 602, for such purpose(s). As also shown, in some circumstances, the resource access application 522 may additionally or alternatively send (658b) a request to the operating system 604 to insert data indicative of the result into the user app 602 and/or the currently presented user interface window for the user app 602, e.g., by calling one or more UI Automation APIs, or using one or more operating system hooks to send the result data to the user interface window for the user app 602 (e.g., as keystrokes to the cursor position or the focused UI element).

As noted previously, although not illustrated in FIG. 1A, the step(s) that are to be taken by the resource access application 522 to insert data indicative of the result into the user app 602 and/or the currently presented user interface window for the user app 602, e.g., the window 118 of User App A shown in FIGS. 1B-F, may be specified within the microapp correlation data 108, e.g., as one or more additional fields.

Further, it should be appreciated that, in some implementations, the user 524 may be provided with the capability to modify the behavior of the system 100 based on the user's preferences. For example, the user 524 may be provided with one or more user interface tools allowing the user to control the circumstances in which options for accessing microapp actions are to be presented, the triggering actions that are to cause such options to be presented, the manner in which result data is to be processed by the resource access application 522 upon receipt, etc. Adjustments to one or more such user preference settings may, for example, cause the microapp correlation data 108 that is maintained by the resource management services 502 on behalf of the user 524, e.g., as a part of the user's profile, and sent to the resource access application, e.g., per the step 612 shown in FIG. 6A, to be modified.

G. Example Implementations of Methods, Systems, and Computer-Readable Media in Accordance with the Present Disclosure

The following paragraphs (M1) through (M12) describe examples of methods that may be implemented in accordance with the present disclosure.

(M1) A method may be performed that involves receiving, by a first application managed by an operating system, first data indicating that a second application managed by the operating system is in a first state; receiving, by the first application, second data indicating that a first user input has been provided to a client device; determining, by the first application and based at least in part on the first data and the second data, that the first user input occurred while the second application was in the first state; and causing, by the first application and based at least in part on the first user input having occurred while the second application was in the first state, the client device to present a first user interface for a third application, the first user interface configured to cause the third application to take a first action with respect to a fourth application in response to a second user input to the client device.

(M2) A method may be performed as described in paragraph (M1), wherein the third application may comprise a microapp, and the method may further involve causing the third application to take the first action at least in part by sending a message to the microapp, wherein the message may cause the microapp to perform the first action via an application programming interface (API) of the fourth application.

(M3) A method may be performed as described in paragraph (M1) or paragraph (M2) through (M3), and may further involve receiving, by the first application, information indicative of a result of the first action performed by the fourth application; and causing, by the first application, the information indicative of the result to be inserted into the second application or a user interface for the second application.

(M4) A method may be performed as described in any of paragraphs (M1) through (M3), wherein the third application may be executing on a computing system that is remote from the client device.

(M5) A method may be performed as described in paragraph (M4), and may further involve receiving, from the computing system, third data that configures the first application to enable presentation of the first user interface if the first data and the second data indicate that the first user input occurred while the second application was in the first state.

(M6) A method may be performed as described in any of paragraphs (M1) through (M5), and may further involve causing, by the first application and based at least in part on the first user input having occurred while the second application was in the first state, the client device to present a first user interface element that, when selected, causes the client device to present the first user interface.

(M7) A method may be performed as described in any of paragraphs (M1) through (M6), wherein the first application may receive the first data from the operating system.

(M8) A method may be performed as described in any of paragraphs (M1) through (M7), and may further involve registering, by the first application, a first event handler with the operating system to cause the operating system to send the first data to the first application.

(M9) A method may be performed as described in any of paragraphs (M1) through (M8), wherein the first application may receive the second data from the operating system.

(M10) A method may be performed as described in any of paragraphs (M1) through (M9), and may further involve registering, by the first application, a second event handler with the operating system to cause the operating system to send the second data to the first application.

(M11) A method may be performed as described in paragraph (M10), wherein the second event handler may be registered with the operating system in response to receipt of the first data from the operating system.

(M12) A method may be performed as described in any of paragraphs (M1) through (M11), and may further involve determining, by the first application, that information presented in a second user interface of the second application has been selected; in response to determining that the information presented in the second user interface has been selected, causing, by the first application, the first user interface to include at least a portion of the selected information; and in response to the second user input, causing the fourth application to perform the first action using the portion of the selected information.

The following paragraphs (S1) through (S12) describe examples of systems and devices that may be implemented in accordance with the present disclosure.

(S1) A system may comprise at least one processor, and at least one computer-readable medium encoded with instructions which, when executed by the at least one processor, cause the system to receive, by a first application managed by an operating system, first data indicating that a second application managed by the operating system is in a first state, to receive, by the first application, second data indicating that a first user input has been provided to a client device, to determine, by the first application and based at least in part on the first data and the second data, that the first user input occurred while the second application was in the first state, and to cause, by the first application and based at least in part on the first user input having occurred while the second application was in the first state, the client device to present a first user interface for a third application, the first user interface configured to cause the third application to take a first action with respect to a fourth application in response to a second user input to the client device.

(S2) A system may be configured as described in paragraph (S1), wherein the third application may comprise a microapp, and the at least one computer-readable medium may be further encoded with additional instructions which, when executed by the at least one processor, further cause the system to cause the third application to take the first action at least in part by sending a message to the microapp, wherein the message may cause the microapp to perform the first action via an application programming interface (API) of the fourth application.

(S3) A system may be configured as described in paragraph (S1) or paragraph (S2), and the at least one computer-readable medium may be further encoded with additional instructions which, when executed by the at least one processor, further cause the system to receive, by the first application, information indicative of a result of the first action performed by the fourth application, and to cause, by the first application, the information indicative of the result to be inserted into the second application or a user interface for the second application.

(S4) A system may be configured as described in any of paragraphs (S1) through (S3), wherein the third application may be located on a computing system that is remote from the client device.

(S5) A system may be configured as described in paragraph (S4), and the at least one computer-readable medium may be further encoded with additional instructions which, when executed by the at least one processor, further cause the system to receive, from the computing system, third data that configures the first application to enable presentation of the first user interface if the first data and the second data indicate that the first user input occurred while the second application was in the first state.

(S6) A system may be configured as described in any of paragraphs (S1) through (S5), and the at least one computer-readable medium may be further encoded with additional instructions which, when executed by the at least one processor, further cause the system to cause, by the first application and based at least in part on the first user input having occurred while the second application was in the first state, the client device to present a first user interface element that, when selected, causes the client device to present the first user interface.

(S7) A system may be configured as described in any of paragraphs (S1) through (S6), wherein the first application may be configured to receive the first data from the operating system.

(S8) A system may be configured as described in any of paragraphs (S1) through (S7), and the at least one computer-readable medium may be further encoded with additional instructions which, when executed by the at least one processor, further cause the system to register, by the first application, a first event handler with the operating system to cause the operating system to send the first data to the first application.

(S9) A system may be configured as described in any of paragraphs (S1) through (S8), wherein the first application may be configured to receive the second data from the operating system.

(S10) A system may be configured as described in any of paragraphs (S1) through (S9), and the at least one computer-readable medium may be further encoded with additional instructions which, when executed by the at least one processor, further cause the system to register, by the first application, a second event handler with the operating system to cause the operating system to send the second data to the first application.

(S11) A system may be configured as described in paragraph (S10), and the at least one computer-readable medium may be further encoded with additional instructions which, when executed by the at least one processor, further cause the second event handler to be registered with the operating system in response to receipt of the first data from the operating system.

(S12) A system may be configured as described in any of paragraphs (S1) through (S11), and the at least one computer-readable medium may be further encoded with additional instructions which, when executed by the at least one processor, further cause the system to determine, by the first application, that information presented in a second user interface of the second application has been selected, to cause, by the first application, the first user interface to include at least a portion of the selected information in response to determining that the information presented in the second user interface has been selected, and to cause the fourth application to perform the first action using the portion of the selected information in response to the second user input.

The following paragraphs (CRM1) through (CRM12) describe examples of computer-readable media that may be implemented in accordance with the present disclosure.

(CRM1) At least one non-transitory computer-readable medium may be encoded with instructions which, when executed by at least one processor of a system, cause the system to receive, by a first application managed by an operating system, first data indicating that a second application managed by the operating system is in a first state, to receive, by the first application, second data indicating that a first user input has been provided to a client device, to determine, by the first application and based at least in part on the first data and the second data, that the first user input occurred while the second application was in the first state, and to cause, by the first application and based at least in part on the first user input having occurred while the second application was in the first state, the client device to present a first user interface for a third application, the first user interface configured to cause the third application to take a first action with respect to a fourth application in response to a second user input to the client device.

(CRM2) At least one non-transitory computer-readable medium may be configured as described in paragraph (CRM1), wherein the third application may comprise a microapp, and the at least one computer-readable medium may be further encoded with additional instructions which, when executed by the at least one processor, further cause the system to cause the third application to take the first action at least in part by sending a message to the microapp, wherein the message may cause the microapp to perform the first action via an application programming interface (API) of the fourth application.

(CRM3) At least one non-transitory computer-readable medium may be configured as described in paragraph (CRM1) or paragraph (CRM2), and may be further encoded with additional instructions which, when executed by the at least one processor, further cause the system to receive, by the first application, information indicative of a result of the first action performed by the fourth application, and to cause, by the first application, the information indicative of the result to be inserted into the second application or a user interface for the second application.

(CRM4) At least one non-transitory computer-readable medium may be configured as described in any of paragraphs (CRM1) through (CRM3), wherein the third application may be located on a computing system that is remote from the client device.

(CRM5) At least one non-transitory computer-readable medium may be configured as described paragraph (CRM4), and may be further encoded with additional instructions which, when executed by the at least one processor, further cause the system to receive, from the computing system, third data that configures the first application to enable presentation of the first user interface if the first data and the second data indicate that the first user input occurred while the second application was in the first state.

(CRM6) At least one non-transitory computer-readable medium may be configured as described in any of paragraphs (CRM1) through (CRM5), and may be further encoded with additional instructions which, when executed by the at least one processor, further cause the system to cause, by the first application and based at least in part on the first user input having occurred while the second application was in the first state, the client device to present a first user interface element that, when selected, causes the client device to present the first user interface.

(CRM7) At least one non-transitory computer-readable medium may be configured as described in any of paragraphs (CRM1) through (CRM6), wherein the first application may be configured to receive the first data from the operating system.

(CRM8) At least one non-transitory computer-readable medium may be configured as described in any of paragraphs (CRM1) through (CRM7), and may be further encoded with additional instructions which, when executed by the at least one processor, further cause the system to register, by the first application, a first event handler with the operating system to cause the operating system to send the first data to the first application.

(CRM9) At least one non-transitory computer-readable medium may be configured as described in any of paragraphs (CRM1) through (CRM8), wherein the first application may be configured to receive the second data from the operating system.

(CRM10) At least one non-transitory computer-readable medium may be configured as described in any of paragraphs (CRM1) through (CRM9), and may be further encoded with additional instructions which, when executed by the at least one processor, further cause the system to register, by the first application, a second event handler with the operating system to cause the operating system to send the second data to the first application.

(CRM11) At least one non-transitory computer-readable medium may be configured as described in paragraph (CRM10), and may be further encoded with additional instructions which, when executed by the at least one processor, further cause the second event handler to be registered with the operating system in response to receipt of the first data from the operating system.

(CRM12) At least one non-transitory computer-readable medium may be configured as described in any of paragraphs (CRM1) through (CRM11), and may be further encoded with additional instructions which, when executed by the at least one processor, further cause the system to determine, by the first application, that information presented in a second user interface of the second application has been selected, to cause, by the first application, the first user interface to include at least a portion of the selected information in response to determining that the information presented in the second user interface has been selected, and to cause the fourth application to perform the first action using the portion of the selected information in response to the second user input.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a first application managed by an operating system, first data indicating that a second application managed by the operating system is in a first state;
receiving, by the first application, second data indicating that a first user input has been provided to a client device;
determining, by the first application and based at least in part on the first data and the second data, that the first user input occurred while the second application was in the first state; and
causing, by the first application and based at least in part on the first user input having occurred while the second application was in the first state, the client device to present a first user interface for a third application, the first user interface configured to cause the third application to take a first action with respect to a fourth application in response to a second user input to the client device.

2. The method of claim 1, wherein the third application is executing on a computing system that is remote from the client device.

3. The method of claim 2, wherein the third application comprises a microapp, and the method further comprises:
causing the third application to take the first action at least in part by sending a message to the microapp, wherein the message causes the microapp to perform the first action via an application programming interface (API) of the fourth application.

4. The method of claim 3, further comprising:
receiving, by the first application, information indicative of a result of the first action performed by the fourth application; and
causing, by the first application, the information indicative of the result to be inserted into the second application or a user interface for the second application.

5. The method of claim 2, further comprising:
receiving, from the computing system, third data that configures the first application to enable presentation of the first user interface if the first data and the second data indicate that the first user input occurred while the second application was in the first state.

6. The method of claim 1, further comprising:
causing, by the first application and based at least in part on the first user input having occurred while the second application was in the first state, the client device to present a first user interface element that, when selected, causes the client device to present the first user interface.

7. The method of claim 1, wherein the first application receives the first data from the operating system.

8. The method of claim 7, further comprising:
registering, by the first application, a first event handler with the operating system to cause the operating system to send the first data to the first application.

9. The method of claim 8, wherein the first application receives the second data from the operating system.

10. The method of claim 9, further comprising:
registering, by the first application, a second event handler with the operating system to cause the operating system to send the second data to the first application.

11. The method of claim 10, wherein the second event handler is registered with the operating system in response to receipt of the first data from the operating system.

12. The method of claim 1, further comprising:
determining, by the first application, that information presented in a second user interface of the second application has been selected;
in response to determining that the information presented in the second user interface has been selected, causing, by the first application, the first user interface to include at least a portion of the selected information; and
in response to the second user input, causing the fourth application to perform the first action using the portion of the selected information.

13. A system, comprising:
at least one processor; and
at least one computer-readable medium encoded with instructions which, when executed by the at least one processor, cause the system to:
receive, by a first application managed by an operating system, first data indicating that a second application managed by the operating system is in a first state,
receive, by the first application, second data indicating that a first user input has been provided to a client device,
determine, by the first application and based at least in part on the first data and the second data, that the first user input occurred while the second application was in the first state, and
cause, by the first application and based at least in part on the first user input having occurred while the second application was in the first state, the client device to present a first user interface for a third application, the first user interface configured to cause the third application to take a first action with respect to a fourth application in response to a second user input to the client device.

14. The system of claim 13, wherein the third application is located on a computing system that is remote from the client device.

15. The system of claim 14, wherein the third application comprises a microapp, and the at least one computer-readable medium is further encoded with additional instructions which, when executed by the at least one processor, further cause the system to:
cause the third application to take the first action at least in part by sending a message to the microapp, wherein the message causes the microapp to perform the first action via an application programming interface (API) of the fourth application.

16. The system of claim 15, wherein the at least one computer-readable medium is further encoded with additional instructions which, when executed by the at least one processor, further cause the system to:
receive, by the first application, information indicative of a result of the first action performed by the fourth application; and
cause, by the first application, the information indicative of the result to be inserted into the second application or a user interface for the second application.

17. The system of claim 14, wherein the at least one computer-readable medium is further encoded with additional instructions which, when executed by the at least one processor, further cause the system to:
receive, from the computing system, third data that configures the first application to enable presentation of the first user interface if the first data and the second data indicate that the first user input occurred while the second application was in the first state.

18. The system of claim 13, wherein the at least one computer-readable medium is further encoded with additional instructions which, when executed by the at least one processor, further cause the system to:
cause, by the first application and based at least in part on the first user input having occurred while the second application was in the first state, the client device to present a first user interface element that, when selected, causes the client device to present the first user interface.

19. The system of claim 13, wherein the at least one computer-readable medium is further encoded with additional instructions which, when executed by the at least one processor, further cause the system to:
determine, by the first application, that information presented in a second user interface of the second application has been selected;
in response to determining that the information presented in the second user interface has been selected, cause, by the first application, the first user interface to include at least a portion of the selected information; and
in response to the second user input, cause the fourth application to perform the first action using the portion of the selected information.

20. At least one non-transitory computer-readable medium encoded with instructions which, when executed by at least one processor of a computing system, cause the computing system to:
receive, by a first application managed by an operating system, first data indicating that a second application managed by the operating system is in a first state;
receive, by the first application, second data indicating that a first user input has been provided to a client device;
determine, by the first application and based at least in part on the first data and the second data, that the first user input occurred while the second application was in the first state; and
cause, by the first application and based at least in part on the first user input having occurred while the second application was in the first state, the client device to present a first user interface for a third application, the first user interface configured to cause the third application to take a first action with respect to a fourth application in response to a second user input to the client device.
